(19) United States
(12) Patent Application Publication
(10) Pub. No.: US 2016/0321380 A1
(43) Pub. Date: Nov. 3, 2016

(54) METHOD AND APPARATUS FOR USE IN THERMAL COUPLED ANALYSIS

(71) Applicant: FUJITSU LIMITED, Kawasaki-shi (JP)

(72) Inventors: Tetsuyuki KUBOTA, Acton (GB); Peter CHOW, Gillingham Kent (GB); Serban GEORGESCU, London (GB); Fujisaki AKIHIKO, Kawasaki-shi (JP)

(73) Assignee: FUJITSU LIMITED, Kawasaki-shi (JP)

(21) Appl. No.: 15/091,016

(22) Filed: Apr. 5, 2016

(30) Foreign Application Priority Data
May 1, 2015 (GB) 1507527.8
Mar. 1, 2016 (EP) 16157990.9

(51) Int. Cl. G06F 17/50; G06F 17/10

(52) U.S. Cl. CPC G06F 17/5009; G06F 17/10

(57) ABSTRACT

A method and system of thermal computational fluid dynamics (CFD) analysis on a structure. A thermal CFD model of the structure is created using 3D-CAD software in which a volume of the structure, encompassing a third part, a portion of a first part which is adjacent to and includes a boundary between the first and third parts, and a portion of the second part which is adjacent to and includes a boundary between the second and third parts, is replaced by a notional fourth part. Thermal-CFD analysis of the thermal CFD model is performed using thermal conductivity of a fourth part that is calculated, based on known thickness of the fourth part, known thickness, the derived shape and known value of the thermal conductivity of the third part, and known values of the thermal conductivity of portions of the first and second parts.

### CROSS-REFERENCE TO RELATED APPLICATIONS

This application claims the priority benefit of United Kingdom Application No.1507527.8, filed May 1, 2015, and European Application No. 16157990.9, filed Mar. 1, 2016, the disclosures of which are incorporated herein by reference.

### BACKGROUND

1. Field

The present application relates to a method and apparatus for use in thermal coupled analysis.

2. Description of the Related Art

Structural and thermal coupled analysis of a structure is usually carried out based on a 3-dimensional computer-aided design (3D-CAD) geometrical model of the structure, in which features of the structure are represented by 3D mesh elements. In 3D-CAD models the mesh size of the mesh elements is dependent upon the size of the features to be modeled, such that for a small feature a large amount of mesh elements are required. The greater the number of mesh elements there are, the higher the computational cost will be.

This is a particular issue in the creation and analysis of a thermal computational fluid dynamics (thermal-CFD) model based on a structure employing a thermal sheet. A typical example of such a structure is shown in FIG. 1(b) of the accompanying drawings. As shown in FIG. 1(a) of the accompanying drawings, in general a contact interface between metal solids A and B has a large thermal resistance. The thermal resistance is large at the boundary, so heat flux which is generated at a heat source in solid B is reduced in magnitude as it passes through the contact interface. As shown in FIG. 1(b), to reduce the thermal resistance between two metal solids A and B, a thermal sheet T is inserted between them. Typically the sheet T has a uniform thickness of the order of 10 to 25 μm and is made of a material with some properties similar to rubber (for example, acrylic polymer, glass-reinforced polyamide, fiberglass-reinforced silicone) but with high heat conductivity. Therefore, using such a thermal sheet T, heat resistance between the metal solids A and B can be reduced.

In general, when used in such a structure, the thermal sheet T will be compressed by uniform force and will retain uniform thickness, as shown in FIG. 2(a) of the accompanying drawings. However, if the load balance across the structure is broken for some reason, the thickness of the thermal sheet T will vary along its length, for example as shown in FIG. 2(b) of the accompanying drawings. Such non-uniform deformation of the thermal sheet T has an effect on the thermal resistance of the thermal sheet T, which in turn changes the heat flux through the thermal sheet T.

This phenomenon has a significant influence on the thermal design. It is therefore important to predict how the thermal sheet T will deform under load and the consequent variation of heat flux.

Structural analysis is used to determine how the thermal sheet T will deform under load and a model for thermal-CFD analysis is generated from the result of the structural analysis. However, as the thickness of the thermal sheet T is of the order of only a few μm and the amount of deformation of the thermal sheet T is smaller than the thickness of thermal sheet T, a large number of mesh elements are required to represent the deformation of the thermal sheet T in the thermal-CFD analysis model.

Some software is available which can perform coupled simulation between structural analysis and thermal-CFD analysis, for example ANSYS (Simulation software for structural analysis, electro-magnetic analysis, CFD and coupled analysis—http://ansys.com/) and HyperWorks (Simulation software for structural analysis, electro-magnetic analysis, CFD and coupled analysis—http://www.altairhyperworks.co.uk/). Although such software can perform coupled analysis, it is necessary for the geometrical CAD model on which analysis is based to be the same for both the structural analysis simulation and the thermal-CFD analysis simulation. As mentioned above, if a small-scale feature exists in a geometrical CAD model, the mesh scale of the mesh elements must be large, and computational cost will be high.

It is desirable to reduce the computational cost of carrying out thermal-CFD analysis of a structure comprising small-scale features, such as a deformed thermal sheet.

### SUMMARY

According to an embodiment of a first aspect of the present invention there is provided a method of carrying out thermal computational fluid dynamics—thermal CFD—analysis on a structure comprising a first part, a second part and a deformable third part located between and in contact with each of the first and second parts, wherein: a thermal CFD model of the structure is created using 3D-CAD software in which a volume of the structure, encompassing the third part, a portion of the first part which is adjacent to and includes a boundary between the first and third parts, and a portion of the second part which is adjacent to and includes a boundary between the second and third parts, is replaced by a notional fourth part, which has a uniform thickness greater than or equal to twice the size of mesh used to mesh the first and second parts; the shape of the third part as deformed under load is derived from structural analysis of a structural analysis model of the structure; a value for the thermal conductivity of the fourth part is calculated, based on a known value of the thickness of the fourth part, a known value of the thickness of the third part, the derived shape of the deformed third part, a known value of the thermal conductivity of the third part, and known values of the thermal conductivity of the portions of the first and second parts; and thermal-CFD analysis of the thermal CFD model is carried out using the calculated thermal conductivity of the fourth part.

Preferably the fourth part is divided into N contiguous regions, each region comprising a first section aᵢ, of thickness Iₐᵢ and thermal conductivity λₐᵢ, and a second section bᵢ of thickness I_{bi} and thermal conductivity λ_{bi}, such that the total thickness of each ith region is Iₐᵢ+I_{bi}, where i is an integer and 1≦i≦N; and the thermal conductivity of the fourth part by adding the thermal conductivity value of each first section aᵢ derived from the equation:

$${λ}_{ai} = \frac{{l}_{ai}}{\begin{matrix}{l}_{ai} - {l}_{Ti} \\ {λ}_{A}\end{matrix} + \begin{matrix}{L}_{Ti} / 2 \\ {λ}_{T}\end{matrix}}$$

and the thermal conductivity value of each second section bᵢ derived from the equation:

$${λ}_{bi} = \frac{{l}_{bi}}{\begin{matrix}{l}_{bi} - {l}_{Ti} \\ {λ}_{B}\end{matrix} + \begin{matrix}{L}_{Ti} / 2 \\ {λ}_{T}\end{matrix}}$$

where under balanced load the third part has a thermal conductivity λ_{T} and a thickness I_{Ti} at the ith region and under unbalanced load the third part has a thickness L_{Ti} at the ith region.

According to an embodiment of a second aspect of the present invention there is provided apparatus for carrying out thermal computational fluid dynamics—thermal CFD—analysis on a structure comprising a first part, a second part and a deformable third part located between and in contact with each of the first and second parts, the apparatus comprising: first processing means configured to create a thermal CFD model of the structure using 3D-CAD software, in which thermal CFD model a volume of the structure, encompassing the third part, a portion of the first part which is adjacent to and includes a boundary between the first and third parts, and a portion of the second part which is adjacent to and includes a boundary between the second and third parts, is replaced by a notional fourth part, which has a uniform thickness greater than or equal to twice the size of mesh used to mesh the first and second parts; second processing means for deriving the shape of the third part as deformed under load from structural analysis of a structural analysis model of the structure; third processing means for calculating a value for the thermal conductivity of the fourth part, based on a known value of the thickness of the fourth part, a known value of the thickness of the third part, the derived shape of the deformed third part, a known value of the thermal conductivity of the third part, and known values of the thermal conductivity of the portions of the first and second parts; and fourth processing means for carrying out thermal-CFD analysis of the thermal CFD model using the calculated thermal conductivity of the fourth part.

Preferably the third processing means are operable to: divide the fourth part into N contiguous regions, each region comprising a first section aᵢ, of thickness Iₐᵢ and thermal conductivity λₐᵢ, and a second section bᵢ of thickness I_{bi} and thermal conductivity λ_{bi}, such that the total thickness of each ith region is Iₐᵢ+I_{bi}, where i is an integer and 1≦i≦N; and determine the thermal conductivity of the fourth part by adding the thermal conductivity value of each first section aᵢ derived from the equation:

$${λ}_{ai} = \frac{{l}_{ai}}{\begin{matrix}{l}_{ai} - {l}_{Ti} \\ {λ}_{A}\end{matrix} + \begin{matrix}{L}_{Ti} / 2 \\ {λ}_{T}\end{matrix}}$$

to the thermal conductivity value of each second section bᵢ derived from the equation:

$${λ}_{bi} = \frac{{l}_{bi}}{\begin{matrix}{l}_{bi} - {l}_{Ti} \\ {λ}_{B}\end{matrix} + \begin{matrix}{L}_{Ti} / 2 \\ {λ}_{T}\end{matrix}}$$

where under balanced load the third part has a thermal conductivity λ_{T} and a thickness I_{Ti} at the ith region and under unbalanced load the third part has a thickness L_{Ti} at the ith region.

The inventors have realised that, although it is still necessary to use the correct geometrical CAD model for structural analysis, it is possible to reduce computational cost by performing thermal-CFD analysis separately using a thermal-CFD model in which a part such as a deformed thermal sheet is represented by its equivalent thermal conductivity rather than 3D mesh elements.

Advantageously, each small-scale part is removed from the 3D geometrical model and replaced with its equivalent thermal conductivity automatically to produce a thermal-CFD model for thermal-CFD analysis.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings. Reference will now be made, by way of example, to the accompanying drawings, in which:

FIG. 1(a) is a schematic diagram illustrating heat flux between two metal solids in a structure, and FIG. 1(b) is a schematic diagram of a modification of the structure of FIG. 1(a) in which a thermal sheet is interposed between the two metal solids;

FIG. 2(a) is a schematic diagram illustrating deformation of the thermal sheet under uniform force, and FIG. 2(b) is a schematic diagram illustrating deformation of the thermal sheet under non-uniform force;

FIG. 3 shows a flowchart of a method for carrying out thermal CFD analysis of a structure based on a 3D-CAD model of the structure;

FIG. 4 is a diagram of apparatus for carrying out the method of FIG. 3;

FIG. 5 shows a flowchart of a process for creating a thermal-CFD model of a structure for use in thermal-CFD analysis;

FIG. 6(a) shows a thermal-CFD model created using the process of FIG. 5, and FIG. 6(b) shows the equivalent thermal circuit model;

FIG. 7 is a schematic diagram illustrating a thermal sheet, which forms part of the structure, before structural analysis;

FIG. 8 is a schematic diagram illustrating the thermal sheet of FIG. 7 after structural analysis; and

FIG. 9 is a diagram comparing a section of the thermal-CFD model of FIG. 6 with a section of the actual model before deformation and a section of the actual model after deformation.

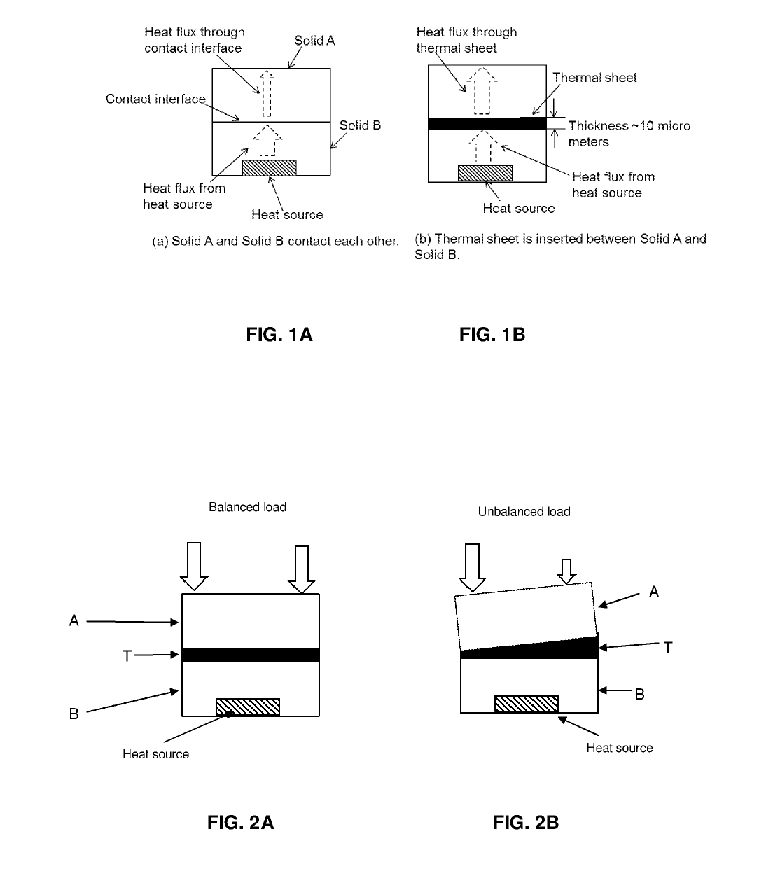

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

An embodiment of the present invention comprises a method of carrying out thermal computational fluid dynamics—thermal CFD—analysis on a structure comprising a first part, a second part and a deformable third part located between and in contact with each of the first and second parts. In this embodiment a thermal CFD model of the structure is created using 3D-CAD software, in which a volume of the structure, encompassing the third part, a portion of the first part which is adjacent to and includes a boundary between the first and third parts, and a portion of the second part which is adjacent to and includes a boundary between the second and third parts, is replaced by a notional fourth part, which has a thickness greater than or equal to twice the size of mesh used to mesh the first and second parts. The shape of the third part as deformed under load is then derived from structural analysis of a structural analysis model of the structure, and a value for the thermal conductivity of the fourth part is calculated, based on a known value of the thickness of the third part, the derived shape of the deformed third part, a known value of the thermal conductivity of the third part, and known values of the thermal conductivity of the portions of the first and second parts. Finally, thermal-CFD analysis of the thermal CFD model is carried out using the calculated thermal conductivity of the fourth part.

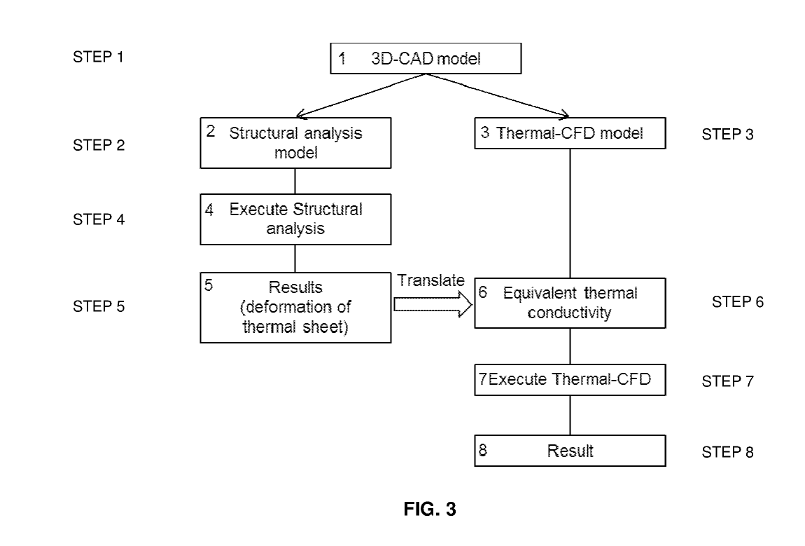

An embodiment of a method for carrying out thermal CFD analysis of a structure based on a 3D CAD model of the structure will now be explained with reference to FIG. 3. In this particular embodiment the structure to be analyzed includes a thermal sheet which is compressed between two solids.

In Step 1 of FIG. 3 a 3D-CAD model of the structure is generated or imported from other software.

In Step 2 the 3D-CAD model is translated to a structural analysis model of the structure.

In Step 3 the 3D-CAD model is translated to a thermal-CFD analysis model using a procedure embodying the present invention, which will be described below.

In Step 4 structural analysis of the structural analysis model is carried out.

In Step 5, based on the result of the structural analysis carried out in Step 4, deformation of the thermal sheet in the structure is derived.

In Step 6 the equivalent thermal conductivity of the deformed thermal sheet obtained in Step 5 is derived, using a process which will be explained later.

In Step 7, thermal-CFD analysis of the thermal-CFD model is carried out using the equivalent thermal conductivity for the deformed thermal sheet obtained in Step 6.

In Step 8 the result of the thermal-CFD analysis is obtained, in which the influence of the deformation of the thermal sheet is included.

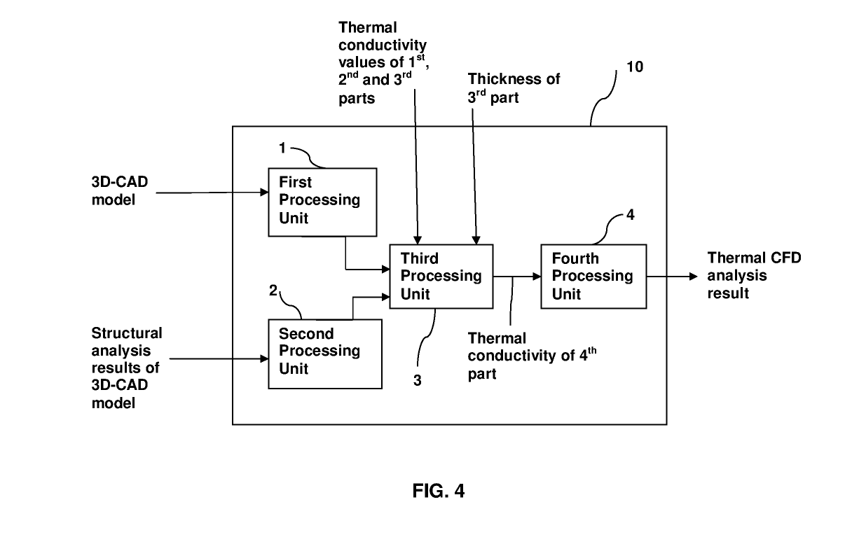

An embodiment of apparatus for carrying out a method embodying the present invention is shown in FIG. 4. As shown in FIG. 4, apparatus 10 comprises a first processing unit 1 (first processing means) configured to create a thermal CFD model of the structure using 3D-CAD software. The first processing unit 1 is operable to create a thermal CFD model in which a volume of the structure, encompassing the third part, a portion of the first part which is adjacent to and includes a boundary between the first and third parts, and a portion of the second part which is adjacent to and includes a boundary between the second and third parts, is replaced by a notional fourth part, which has a thickness greater than or equal to twice the size of mesh used to mesh the first and second parts. Apparatus 10 further comprises a second processing unit 2 (second processing means), configured to derive the shape of the third part as deformed under load from structural analysis of a structural analysis model of the structure, and a third processing unit 3 (third processing means), configured to calculate a value for the thermal conductivity of the fourth part, based on a known value of the thickness of the third part, the derived shape of the deformed third part, a known value of the thermal conductivity of the third part, and known values of the thermal conductivity of the portions of the first and second parts. The apparatus 10 further comprises a fourth processing unit 4 (fourth processing means) configured to carry out thermal-CFD analysis of the thermal CFD model using the calculated thermal conductivity of the fourth part.

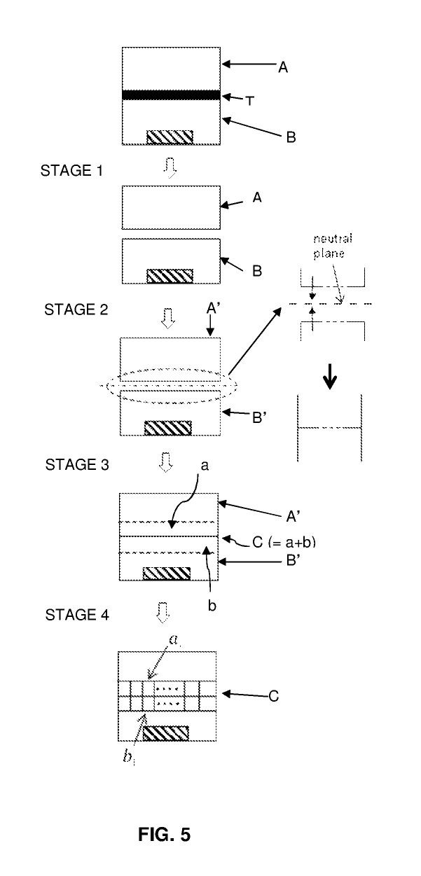

The detailed process of the creation of a thermal-CFD model using 3D-CAD software for use in the thermal-CFD analysis (step 3 in FIG. 3) will now be described with reference to FIG. 5.

The structure to be analyzed comprises an upper solid, a lower solid and a thermal sheet located between and in contact with each of the upper and lower solids. A CAD model of the structure comprises a first part A representing the upper solid and having a first contact face, a second part B representing the lower solid and having a second contact face, and a third part T representing the thermal sheet.

The position of the neutral plane of the third part T relative to the first and second parts A, B is noted and the geometrical CAD model of the structure is modified so as to remove the third part T (stage 1). This may be done either by the user of the CAD software or automatically by software on the basis of information stored in a materials database (e.g. the name of the material property, a flag, thermal conductivity value, etc.).

The modified CAD model is then modified further by moving the first and second contact faces of the first and second parts A, B to the position previously occupied by the neutral plane of the third part T, creating modified first and second parts A′, B′ which meet at a contact plane positioned where the neutral plane of the third part T used to be (stage 2).

An arbitrary portion of the modified first part A′ which is adjacent to the contact plane between A′ and B′ is then denoted a, and an arbitrary portion of the modified first part B′ which is adjacent to the contact plane between A′ and B′ is then denoted b (stage 3). The thickness of each new portion a, b is larger than that of the third part T. The result a+b is a notional fourth part C which has a uniform thickness greater than or equal to the size of mesh used to mesh the first and second parts.

Then the thermal CFD model is completed by dividing each portion a and b respectively into N contiguous sections aᵢ, bᵢ of arbitrary length, where i=1, 2, . . . , N and N is defined by the user of the software, for example such that there is no more than a 10% difference in length between adjacent sections (stage 4).

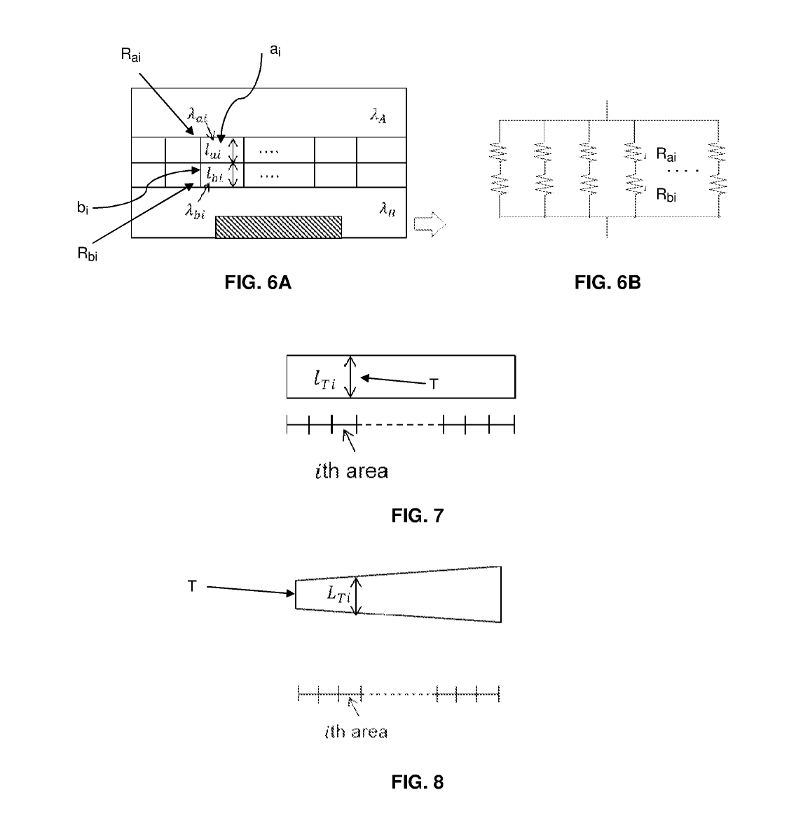

An embodiment of a process of determining the equivalent thermal conductivity of the deformed thermal sheet (step 6 in FIG. 3) will now be described with reference to FIGS. 6, 7, 8 and 9.

FIG. 6(a) shows a thermal-CFD model created using the process of FIG. 5. As shown in FIG. 6(a), the thicknesses of sections aᵢ and bᵢ are defined as Iₐᵢ and I_{bi} respectively. The heat conductivity of solid A is defined as λ_{A} and the heat conductivity of solid B is defined as λ_{B}. The heat conductivity of section aᵢ is defined as λₐᵢ and the heat conductivity of section bᵢ is defined as λ_{bi}. The thermal resistance of the section aᵢ is defined as Rₐᵢ and the thermal resistance of the section bᵢ is defined as R_{bi}.

The thermal characteristics of the part C can be expressed as a thermal circuit model as shown in FIG. 6(b).

Therefore, the thermal resistance Rₜₒₜₐₗ at the part C is given as:

$$\frac{1}{{R}_{total}} = {\sum }_{i = 1}^{N} \frac{1}{{R}_{ai} + {R}_{bi}} {R}_{total} = \frac{1}{{\sum }_{i = 1}^{N} \frac{1}{{R}_{ai} + {R}_{bi}}} \qquad ( 1 )$$

FIG. 7 shows the thermal sheet T under balanced load, before structural analysis, divided into N regions i. The average thickness of thermal sheet T at the ith region is defined as I_{Ti}, and the heat conductivity of thermal sheet T is defined as λ_{T}.

FIG. 8 shows the thermal sheet T under unbalanced load after structural analysis, divided into N regions i. The thickness of the thermal sheet T at the ith region derived from the structural analysis (step 5 of FIG. 3) is defined as L_{Ti}.

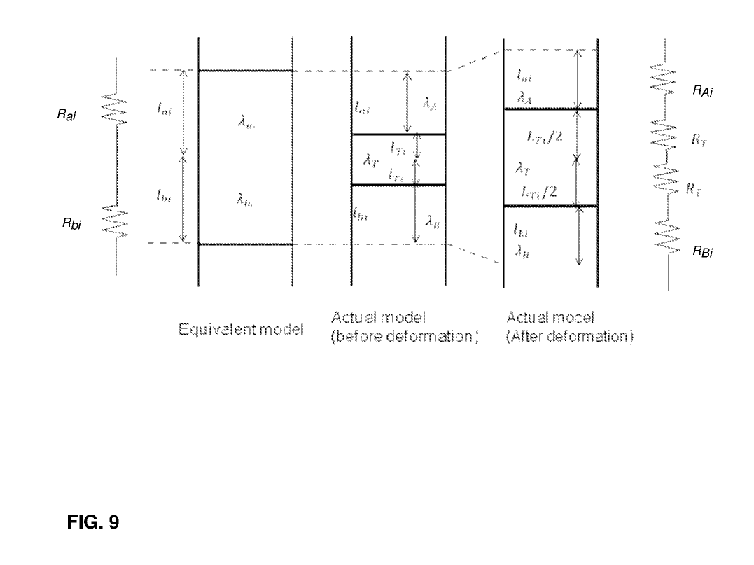

As shown in FIG. 9, thermal resistance of the equivalent model needs to be the same as that of the actual model after deformation. That is:

Rₐᵢ=R_{Ai}+R_{Ti}, R_{bi}=R_{Ti}+R_{Bi} (2)

where Rₐᵢ is the thermal resistance of the section aᵢ, R_{bi} is the thermal resistance of the section bᵢ, R_{Ai} is the thermal resistance of the first part A, R_{Bi} is the thermal resistance of the second part B, and R_{Ti} is the thermal resistance of the third part T.

The thermal resistances can be defined as:

$${R}_{ai} = \frac{{l}_{ai}}{{λ}_{ai}} , \\ {R}_{Ai} = \frac{{l}_{ai} - {l}_{Ti}}{{λ}_{A}} , \\ {R}_{Ti} = \frac{{L}_{Ti} / 2}{{λ}_{T}} \qquad ( 3 )$$

(with similar equations for R_{bi} and R_{Bi} as for Rₐᵢ and R_{Ai} respectively).

Using the equations (2) and (3), equations (4) and (5) can be derived for the heat conductivities λₐᵢ and λ_{bi}:

$$\begin{matrix}{λ}_{ai} = \frac{{l}_{ai}}{\begin{matrix}{l}_{ai} - {l}_{Ti} \\ {λ}_{A}\end{matrix} + \begin{matrix}{L}_{Ti} / 2 \\ {λ}_{T}\end{matrix}} & ( 4 ) \\ {λ}_{bi} = \frac{{l}_{bi}}{\begin{matrix}{l}_{bi} - {l}_{Ti} \\ {λ}_{B}\end{matrix} + \begin{matrix}{L}_{Ti} / 2 \\ {λ}_{T}\end{matrix}} & ( 5 )\end{matrix}$$

Since the thickness of part C is uniform, Iₐ₁, Iₐ₂, . . . , I_{aN} are the same. Additionally, I_{b1}, I_{b2}, . . . , I_{bN} are the same. Therefore the thickness Iₐᵢ (where Iₐ₁=Iₐ₂=Iₐ₃= . . . =I_{aN}) of section aᵢ can be defined as Iₐ and the thickness I_{bi} (where I_{b1}=I_{b2}=I_{b3}= . . . =I_{bN}) of section bᵢ can be described as I_{b}.

In addition Rₜₒₜₐₗ can be defined as:

$${R}_{total} = \frac{{l}_{a} + {l}_{b}}{{λ}_{total}} \qquad ( 6 )$$

where λₜₒₜₐₗ is the equivalent heat conductivity of the part C.

Using equations (1) and (6)

$$\frac{{l}_{a} + {l}_{b}}{{λ}_{total}} = \frac{1}{{\sum }_{i = 1}^{N} \frac{1}{{R}_{ai} + {R}_{bi}}}$$

So the equivalent heat conductivity of the part C is:

$${λ}_{total} = ( {l}_{a} + {l}_{b} ) {\sum }_{i = 1}^{N} \frac{1}{{R}_{ai} + {R}_{bi}}$$

Any or all the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of carrying out thermal computational fluid dynamics (CFD) analysis on a structure including a first part, a second part and a deformable third part located between and in contact with each of the first and second parts, the method comprising:
creating a thermal CFD model of the structure using 3D-CAD software in which a volume of the structure, encompassing the third part, a portion of the first part which is adjacent to and includes a boundary between the first part and the third part, and a portion of the second part which is adjacent to and includes a boundary between the second part and the third part, is replaced by a notional fourth part, which has a uniform thickness greater than or equal to twice a size of mesh used to mesh the first part and the second part;
deriving a shape of the third part as deformed under load from structural analysis of a structural analysis model of the structure;
calculating a value for the thermal conductivity of the fourth part, based on a known value of the thickness of the fourth part, a known value of the thickness of the third part, the derived shape of the deformed third part, a known value of the thermal conductivity of the third part, and known values of thermal conductivity of portions of the first part and the second part; and
performing thermal-CFD analysis of the thermal CFD model using the calculated thermal conductivity of the fourth part.

2. A method as claimed in claim 1, wherein:
the fourth part is divided into N contiguous regions, each region comprising a first section aᵢ, of thickness Iₐᵢ and thermal conductivity λₐᵢ, and a second section bᵢ of thickness I_{bi} and thermal conductivity λ_{bi}, such that the total thickness of each ith region is Iₐᵢ+I_{bi}, where i is an integer and 1≦i≦N; and
the thermal conductivity of the fourth part is determined by adding the thermal conductivity value of each first section aᵢ derived from the equation:
$${λ}_{ai} = \frac{{l}_{ai}}{\begin{matrix}{l}_{ai} - {l}_{Ti} \\ {λ}_{A}\end{matrix} + \begin{matrix}{L}_{Ti} / 2 \\ {λ}_{T}\end{matrix}}$$
and the thermal conductivity value of each second section bᵢ derived from the equation:
$${λ}_{bi} = \frac{{l}_{bi}}{\begin{matrix}{l}_{bi} - {l}_{Ti} \\ {λ}_{B}\end{matrix} + \begin{matrix}{L}_{Ti} / 2 \\ {λ}_{T}\end{matrix}}$$
where under balanced load the third part has a thermal conductivity λ_{T} and a thickness I_{Ti} at the ith region and under unbalanced load the third part has a thickness L_{Ti} at the ith region.

3. Apparatus for carrying out thermal computational fluid dynamics (CFD) analysis on a structure including a first part, a second part and a deformable third part located between and in contact with each of the first part and the second part, the apparatus comprising:
a first processing unit configured to create a thermal CFD model of the structure using 3D-CAD software, in which thermal CFD model a volume of the structure, encompassing a third part, a portion of the first part which is adjacent to and includes a boundary between the first part and the third part, and a portion of the second part which is adjacent to and includes a boundary between the second part and the third part, is replaced by a notional fourth part, which has a thickness greater than or equal to twice a size of mesh used to mesh the first and second parts;
a second processing unit configured to derive a shape of the third part as deformed under load from structural analysis of a structural analysis model of the structure;
a third processing unit configured to calculate a value for the thermal conductivity of the fourth part, based on a known value of the thickness of the fourth part, a known value of the thickness of the third part, the derived shape of the deformed third part, a known value of the thermal conductivity of the third part, and known values of the thermal conductivity of the portions of the first and second parts; and
a fourth processing unit configured to carry out thermal-CFD analysis of the thermal CFD model using the calculated thermal conductivity of the fourth part.

4. Apparatus as claimed in claim 3, wherein: the third processing means are operable to:
divide the fourth part into N contiguous regions, each region comprising a first section aᵢ, of thickness Iₐᵢ and thermal conductivity λₐᵢ, and a second section bᵢ of thickness I_{bi} and thermal conductivity λ_{bi}, such that the total thickness of each ith region is Iₐᵢ+I_{bi}, where i is an integer and 1≦i≦N; and
determine the thermal conductivity of the fourth part by adding the thermal conductivity value of each first section aᵢ derived from the equation:
$${λ}_{ai} = \frac{{l}_{ai}}{\begin{matrix}{l}_{ai} - {l}_{Ti} \\ {λ}_{A}\end{matrix} + \begin{matrix}{L}_{Ti} / 2 \\ {λ}_{T}\end{matrix}}$$
to the thermal conductivity value of each second section bᵢ derived from the equation:
$${λ}_{bi} = \frac{{l}_{bi}}{\begin{matrix}{l}_{bi} - {l}_{Ti} \\ {λ}_{B}\end{matrix} + \begin{matrix}{L}_{Ti} / 2 \\ {λ}_{T}\end{matrix}}$$
where under balanced load the third part has a thermal conductivity λ_{T} and a thickness I_{Ti} at the ith region and under unbalanced load the third part has a thickness L_{Ti} at the ith region.
